(19) United States
(12) Patent Application Publication
(10) Pub. No.: US 2021/0089614 A1
(43) Pub. Date: Mar. 25, 2021

(54) Automatically Styling Content Based On Named Entity Recognition

(71) Applicant: Adobe Inc., San Jose, CA (US)

(72) Inventors: Arihant Jain, Nodia (IN); Rishav Agarwal, Nodia (IN); Gaurav Bhargava, Noida (IN)

(73) Assignee: Adobe Inc., San Jose, CA (US)

(21) Appl. No.: 16/580,891

(22) Filed: Sep. 24, 2019

(51) Int. Cl. G06F 17/21; G06N 20/00; G06K 9/62; G06F 17/27

(52) U.S. Cl. CPC G06F 17/212; G06F 17/278; G06K 9/6263; G06N 20/00

(57) ABSTRACT

An automatic content styling system receives digital content, an indication of a style, and an indication of a named entity category. The occurrences of the indicated named entity category in the digital content are identified using a trained machine learning system and the indicated style is automatically applied to the identified occurrences, resulting in styled digital content. User inputs to the styled digital content are also monitored and false positives (occurrences of the indicated named entity category that were not actually the named entity category) and false negatives (occurrences of the indicated named entity category that were not identified) are identified. These false positives and false negatives are used to further train the machine learning system.

### BACKGROUND

Computers are used in many different aspects of our lives. One such use is the creation of digital content, such as news articles, product or service brochures, promotional materials, and so forth. Digital content oftentimes includes text and users oftentimes desire to apply different styles to different portions of the text, such as different fonts, different font sizes, different font types, different colors, and so forth. For example, a user may desire to apply a particular style to the names of all companies mentioned in the digital content.

One technique for applying different styles to different portions text in digital content is to apply the styles manually. This is a tedious process requiring the user to manually select each portion of the digital content he desires to apply a particular style to and manually enter the style settings for each of those selected portions.

Another technique for applying different styles to different portions of text in digital content is to use regular expressions to define rules regarding when a particular style is to apply. However, these rules typically require the user to identify and describe a pattern that differentiates the text he desires to apply one style to from the text he desires to apply another style to. These rules can be complicated and difficult to create, and in some situations simply cannot be created.

Thus, current digital content creation systems lack a simple way for users to apply different styles to different portions of text in digital content, which can result in user dissatisfaction and frustration with their computers and digital content creation systems.

### SUMMARY

To mitigate the drawbacks of digital content creation systems, an automatic content styling system as implemented by a computing device is described to automatically apply a style to occurrences of one or more named entity categories in digital content. An indication of a style to apply to digital content and an indication of at least one named entity category to which the style is to be applied are obtained. One or more occurrences of the at least one named entity category in the digital content are identified by a machine learning system trained to identify the at least one named entity category. Each of the one or more occurrences of the at least one named entity category in the digital content is automatically formatted with the style, resulting in styled digital content that is caused to be displayed. A false negative or a false positive in the one or more occurrences of the at least one named entity category in the digital content is identified, and the machine learning system is trained based on the false negative or the false positive.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures may be indicative of one or more entities and thus reference may be made interchangeably to single or plural forms of the entities in the discussion.

FIG. 1 is an illustration of a digital medium environment in an example implementation that is operable to employ the automatically styling content based on named entity recognition described herein.

FIG. 2 is an illustration of an example architecture of an automatic content styling system.

FIG. 3 illustrates an example user interface allowing a user to specify a style and one or more named entity categories.

FIG. 4 illustrates an example of the operation of the automatic content styling system.

FIG. 5 illustrates another example of the operation of the automatic content styling system.

FIG. 6 is a flow diagram depicting a procedure in an example implementation of automatically styling content based on named entity recognition.

FIG. 7 illustrates an example system including various components of an example device that can be implemented as any type of computing device as described and/or utilized with reference to FIGS. 1-6 to implement aspects of the techniques described herein.

### DETAILED DESCRIPTION

Overview

Current solutions for applying different styles to different portions of text in digital content include applying the different styles manually, which is a tedious and cumbersome process for the user. Other solutions include using regular expressions to define rules regarding when a particular style is to apply. However, these rules can be complicated and difficult to create, and in some situations simply cannot be created.

To overcome these problems an automatic content styling system automatically identifies, and applies a user specified style to, occurrences of one or more user specified named entity categories in digital content. Generally, digital content, an indication of a style, and an indication of a named entity category are obtained. The style refers to one or more attributes that control the appearance of characters, such as a font, a font size, a font type, a font style (e.g., italics, bold, or neither), a color, and so forth. The named entity category refers to one of multiple categories of named entities. A named entity refers to an object that can be named, such as persons, locations, organizations, products, and so forth. An occurrence of a named entity category in the digital content refers to one or more characters in the digital content that are identified or classified as being part of that named entity category.

The occurrences of the indicated named entity category in the digital content are recognized (identified) using a trained machine learning system and the indicated style is automatically applied to the identified occurrences, resulting in styled digital content. User inputs to the styled digital content are also monitored and false positives (occurrences of the indicated named entity category that were not actually the named entity category) and false negatives (occurrences of the indicated named entity category that were not identified) are identified. These false positives and false negatives are used to further train the machine learning system.

More specifically, the automatic content styling system receives user input specifying a style and one or more named entity categories. These inputs indicate a style that is to be applied to all occurrences of the one or more named entity categories. In one or more implementations, user input specifying one or more conditions that are to be satisfied in order for the style to be applied to an occurrence of a named entity category is also received. These one or more conditions can be specified in various manners, such as using regular expressions. Thus, rather than applying the specified style to all occurrences of the specified one or more named entity categories, the specified style can be applied to only occurrences of the specified one or more named entity categories that satisfy the specified one or more conditions.

One or more occurrences of the specified one or more named entity categories are identified in digital content. The one or more occurrences are identified by a machine learning system trained to identify the specified one or more named entity categories. A single machine learning system may be used that is a multi-classification system trained to identify each of multiple different categories. Additionally or alternatively, multiple machine learning systems may be used each trained to identify a subset (e.g., a single one) of multiple different categories.

The specified style, including attribute settings for the style, are applied to the identified one or more occurrences, resulting in styled digital content. Applying the specified style an occurrence of the one or more named entity categories includes changing the style of the occurrence to the specified style. For example, the attribute settings of the occurrence are changed to the attribute settings indicated in the specified style. The specified style can be applied to all of the identified one or more occurrences, or the specified style can be applied to only ones of the identified one or more occurrences that satisfy user specified one or more conditions.

The automatic content styling system also causes the styled digital content to be displayed or otherwise output (e.g., stored on a storage device, transmitted to another computing device for storage or display). Additional user input is also received after generation of the styled digital content. This additional user input can include style changes to one or more characters in the digital content.

The automatic content styling system monitors this additional user input and identifies false positives (occurrences of the one or more named entity categories that were not actually the named entity category) and false negatives (occurrences of the one or more named entity categories that were not identified). The automatic content styling system uses these false positives and false negatives to further train the one or more machine learning systems, adjusting various weights in the machine learning system to minimize a loss function based on the false positives or false negatives. The one or more machine learning systems can thus be continually learning over time while in use, improving the accuracy of identifying named entity categories while the user is using the automatic content styling system.

False positives and false negatives can be identified in a variety of different manners. In one or more implementations, user input is received specifying one or more characters (e.g., specifying at least one word or number) in the styled digital content that are a false positive or a false negative. For example, the user can specify one or more such characters by selecting the one or more characters (e.g., highlighting the characters, touching or clicking on a word in a sentence) and selecting a user interface element (e.g., a button, an icon, a menu item) or providing another input (e.g., audible input, gesture) indicating “false positive” or “false negative”.

The automatic content styling system can also apply the user specified style to the false negative. In one or more implementations the automatic content styling system maintains a record of the one or more occurrences of the one or more named entity categories to which the specified style was applied as well as the style (e.g., attribute settings) for each such occurrence prior to application of the specified style. This allows the automatic content styling system to undo the application of the specified style indication to an identified occurrence of the one or more named entity categories, returning that identified occurrence to the style it had prior to application of the specified style. Accordingly, the automatic content styling system can undo the application of the specified style in response to user specification of a false positive.

Additionally or alternatively, the automatic content styling system automatically identifies false positives and false negatives. In one or more implementations, the automatic content styling system automatically identifies a false negative by detecting that one or more characters (e.g., one or more words or numbers) that were not identified as an occurrence of the specified one or more named entity categories are changed by the user to be the same style as the specified style. Those one or more characters are identified as being a false negative. The automatic content styling system automatically identifies a false positive by detecting that one or more characters that were identified as an occurrence of the specified one or more named entity categories are changed by the user to no longer have the specified style. The automatic content styling system, maintaining a record of the one or more occurrences of the one or more named entity categories to which the specified style was applied as well as the style, can further detect if the user input changes the style of one or more characters to be the style the one or more characters had prior to application of the specified style. A false positive can be identified by detecting that one or more characters (e.g., one or more words or numbers) that were identified as an occurrence of the one or more named entity categories are changed by the user to be the style the one or more characters had prior to application of the specified style.

The techniques discussed herein automatically identify at least one user specified named entity category in digital content and apply a user specified style to the identified at least one user specified named entity category. This provides a more efficient user interface allowing the user to quickly specify styles for named entity categories and have those styles applied to all occurrences of those named entity categories regardless of the locations of those occurrences in the digital content.

Furthermore, the techniques discussed herein reduce the amount of time the user expends in generating digital content because he or she need not manually style particular named entity categories and need not attempt to identify patterns regarding where those named entity categories are located in the digital content. These styles can be applied quickly even for long documents (e.g., hundreds or thousands of pages), thus saving the user a significant amount of time. Reducing the amount of time the user expends in generating digital content saves the user time and reduces device resource usage (e.g., power).

In the following discussion, an example environment is described that may employ the techniques described herein. Example procedures are also described which may be performed in the example environment as well as other environments. Consequently, performance of the example procedures is not limited to the example environment and the example environment is not limited to performance of the example procedures.

Example Environment

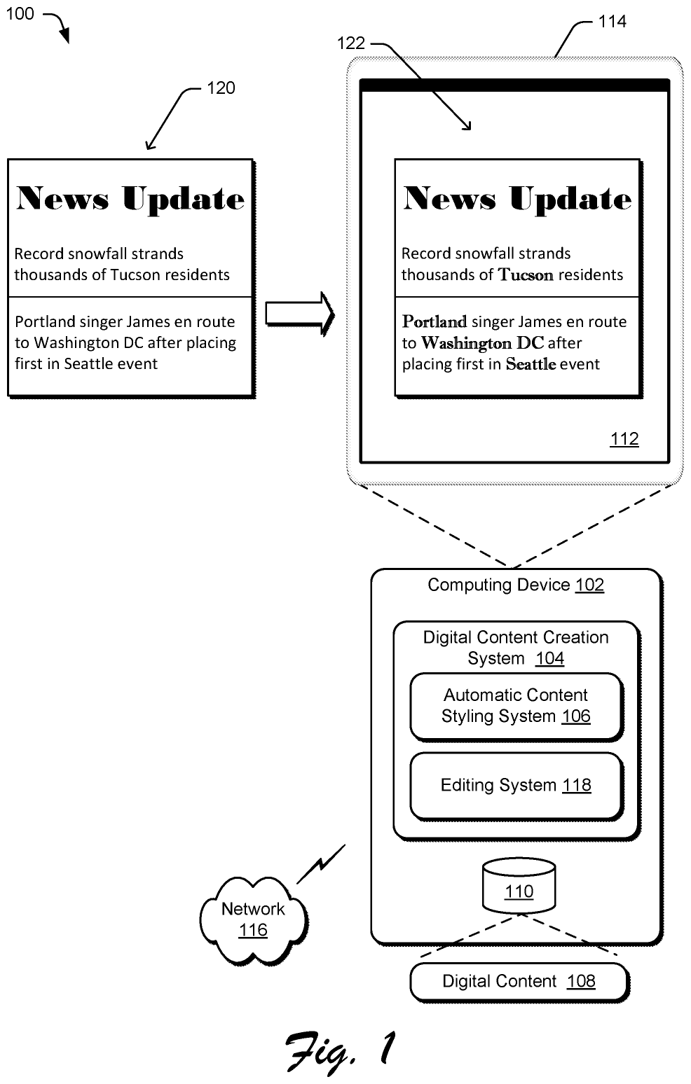

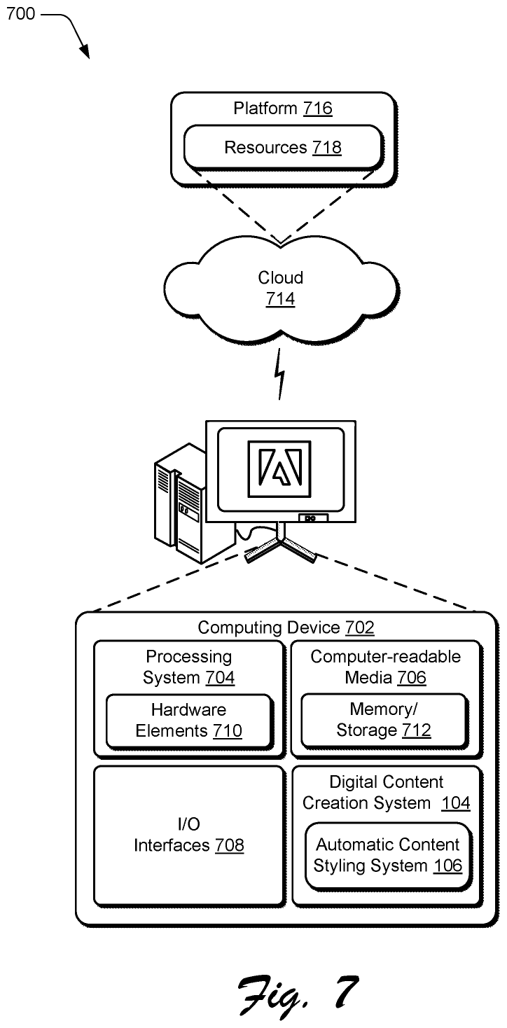

FIG. 1 is an illustration of a digital medium environment 100 in an example implementation that is operable to employ the automatically styling content based on named entity recognition described herein. The illustrated environment 100 includes a computing device 102, which may be configured in a variety of ways. The computing device 102, for instance, may be configured as a mobile device (e.g., assuming a handheld configuration such as a tablet or mobile phone), a wearable device (e.g., augmented reality or virtual reality headsets), a camera, a laptop computer, a desktop computer, and so forth. Thus, the computing device 102 may range from full resource devices with substantial memory and processor resources (e.g., personal computers, game consoles) to a low-resource device with limited memory and/or processing resources (e.g., mobile devices). Additionally, although a single computing device 102 is shown, the computing device 102 may be representative of a plurality of different devices, such as multiple servers utilized by a business to perform operations “over the cloud” as described in FIG. 7.

The computing device 102 is illustrated as including a digital content creation system 104 that includes an automatic content styling system 106. The digital content creation system 104 is implemented at least partially in hardware of the computing device 102 to process and transform digital content 108, which is illustrated as maintained in storage 110 of the computing device 102. Such processing includes creation of the digital content 108 and rendering of the digital content 108 in a user interface 112 for output, e.g., by a display device 114. The digital content 108 refers to any of a variety of different types of digital content that include characters (e.g., letters, numbers, symbols), such as articles (e.g., news articles or scholarly articles), brochures (e.g., for products or services), promotional materials, and so forth. The storage 110 can be any of a variety of different types of storage, such as random access memory (RAM), Flash memory, solid state drive, magnetic disk drive, and so forth. Although illustrated as implemented locally at the computing device 102, functionality of the digital content creation system 104, including the automatic content styling system 106, may also be implemented in whole or part via functionality available via a network 116, such as part of a web service or “in the cloud.”

The digital content creation system 104 implements functionality to allow a user to create digital content. A user can create digital content from scratch, can create digital content by editing previously created digital content, and so forth. The digital content creation system 104 includes an editing system 118 that implements functionality to allow the user to design the digital content he or she desires, including one or more of selecting styles for characters, selecting paragraph formatting and placement, inputting characters or other content (e.g., digital images, video, audio), and so forth.

The automatic content styling system 106 implements functionality to automatically apply a style to characters that are part of a certain named entity category in the digital content. The style refers to one or more attributes that control the appearance of the characters, such as a font, a font size, a font type, a font style (e.g., italics, bold, or neither), a color, and so forth. The automatic content styling system 106 can apply a style to various named entity categories, such as persons, locations, organizations, products, and so forth. The automatic content styling system 106 receives user input specifying a style and one or more named entity categories, and the automatic content styling system 106 automatically identifies (also referred to as recognizes) the occurrences of the specified one or more named entity categories in the digital content and automatically applies the specified style to the identified occurrences. An example of such digital content is illustrated as digital content 120, which is transformed to digital content 122 by applying a different font and a font style of “bold” to named entity categories that are geographic names (e.g., names of countries, cities, states, provinces, and so forth).

In general, functionality, features, and concepts described in relation to the examples above and below may be employed in the context of the example systems and procedures described herein. Further, functionality, features, and concepts described in relation to different figures and examples in this document may be interchanged among one another and are not limited to implementation in the context of a particular figure or procedure. Moreover, blocks associated with different representative procedures and corresponding figures herein may be applied together and/or combined in different ways. Thus, individual functionality, features, and concepts described in relation to different example environments, devices, components, figures, and procedures herein may be used in any suitable combinations and are not limited to the particular combinations represented by the enumerated examples in this description.

Automatic Content Styling System Architecture

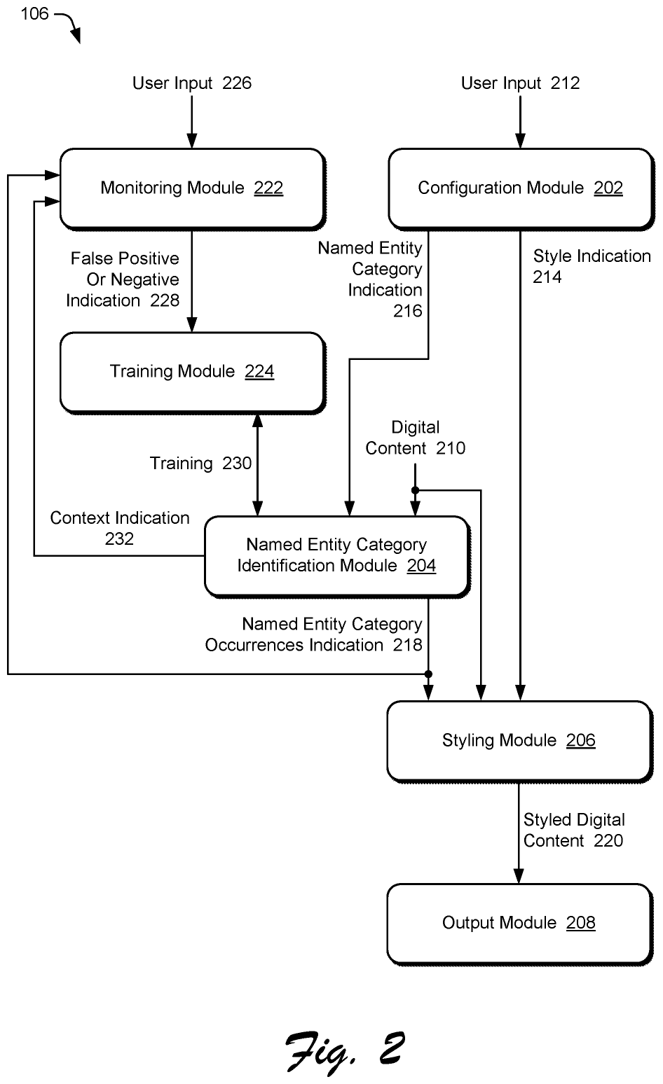

FIG. 2 is an illustration of an example architecture of an automatic content styling system 106. The automatic content styling system 106 includes a configuration module 202, a named entity category identification module 204, a styling module 206, and an output module 208.

Generally, the named entity category identification module 204 receives digital content 210 as an input. The digital content 210 is the digital content that a user is creating using the digital content creation system 104. The configuration module 202 receives user input 212 specifying a style and one or more named entity categories, provides an indication of the style 214 to the styling module 206, and provides an indication of the one or more named entity categories 216 to the named entity category identification module 204. The named entity category identification module 204 identifies the occurrences of the indicated one or more named entity categories 216 in the digital content 210. An indication of those occurrences 218 is provided to the styling module 206. The styling module 206 applies the indicated style 214 to the occurrences of the named entity category 218 in the digital content 210 to generate styled digital content 220. The styling module 206 provides the styled digital content 220 to the output module 208, which causes the styled digital content 220 to be displayed.

The automatic content styling system 106 also includes a monitoring module 222 and a training module 224. The monitoring module 222 receives user input 226 specifying changes to the content as well as named entity category occurrences indication 218. The monitoring module 222 identifies false positives generated by the named entity category identification module 204 (occurrences of the named entity category identified by the named entity category identification module 204 that were not actually the named entity category) and false negatives generated by the named entity category identification module 204 (occurrences of the named entity category that were not identified by the named entity category identification module 204). In response to detecting a false positive or a false negative, the monitoring module 222 provides a false positive or negative indication 228 to the training module 224, indicating the style change that was made. The training module 224 uses the false positive or negative indication 228 to further train 230 the named entity category identification module 204.

More specifically, the configuration module 202 implements functionality to receive user input 212 specifying a style and one or more named entity categories. The user input 212 can be received in any of a variety of different manners, such as user inputs to a graphical user interface, audible inputs, and so forth. In one or more implementations, the configuration module 202 displays a user interface allowing the user to select a style and one or more named entity categories (e.g., from drop down menus, from checkboxes or buttons, etc.).

Named entities can be grouped or classified into multiple different categories, including user-defined categories. Table I shows an example of various different named entity categories into which named entities can be grouped or classified. It is to be appreciated that Table I is only an example, and that named entities can be grouped or classified into different categories than those shown in Table I.

TABLE I

| Category | Description |
|---|---|
| Person | People, both fictional and non-fictional |
| Organization | Companies, agencies, institutions, and so forth |
| Facility | Buildings, airports, highways, bridges, malls, and so forth |
| Event | Sporting events, battles, wars, named storms, and so forth |
| Product | Objects, vehicles, foods, and so forth |
| Money | Monetary values, including unit |
| Group | Nationalities, religious or political groups, and so forth |
| Geographic | Countries, cities, states, provinces, and so forth |
| Location | Locations that are not in the Geographic category, such as |
| | mountain ranges, bodies of water, forests |
| Work of Art | Titles of books, songs, movies, and so forth |
| Law | Named documents made into laws |
| Language | Named languages |
| Date | Absolute or relative dates or periods |
| Time | Times smaller than a day |
| Percent | Percentage values |
| Quantity | Measurements, such as weights or distances |
| Ordinal | Ordinal number, such as “first” or “second” |
| Cardinal | Numerals that are not in any other category |

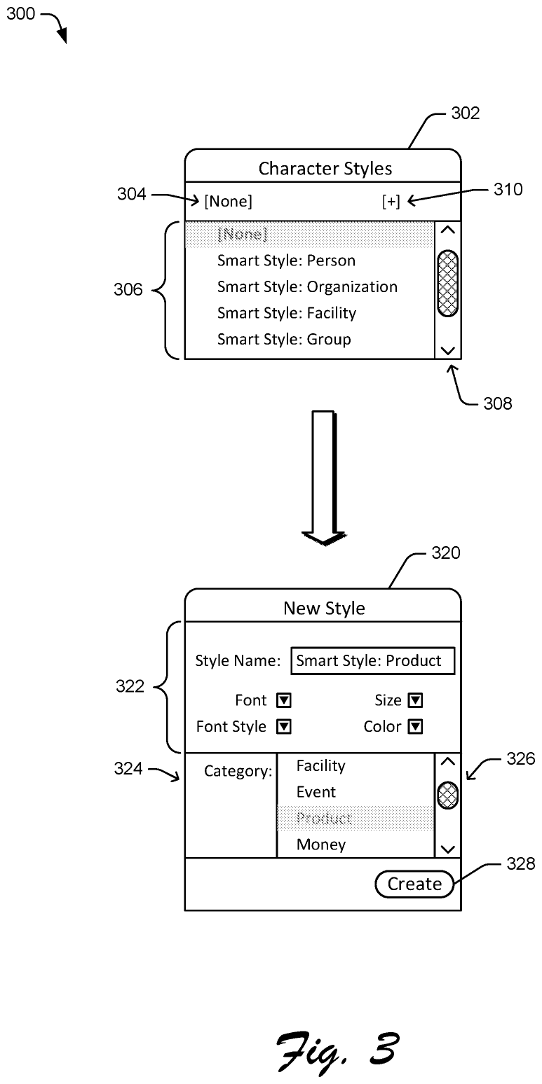

FIG. 3 illustrates an example user interface 300 allowing a user to specify a style and one or more named entity categories. The user interface 300 includes a character style selection screen 302 allowing a user to select one of multiple different styles and corresponding named entity category. An indication of the current style 304 that is selected is displayed, illustrated as “[None]” to indicate that no style is currently selected. Portion 306 displays multiple user selectable styles, also identifying a currently selected style and corresponding named entity category (e.g., by shadowing or highlighting the currently selected style). These user selectable styles are predefined styles, such as default styles, styles previously defined by the user, and so forth. As illustrated, the styles include a style named “Smart Style: Person” indicating that the style is applied to the named entity category of “Person”, a style named “Smart Style: Organization” indicating that the style is applied to the named entity category of “Organizations”, a style named “Smart Style: Facility” indicating that the style is applied to the named entity category of “Facility”, and a style named “Smart Style: Group” indicating that the style is applied to the named entity category of “Group”. A scroll bar 308 allows the user to scroll through multiple different styles. A new style option 310, illustrated as “[+]”, can be selected by the user to create a new style that is added to the multiple user selectable styles in portion 306. The user can select one or more styles from the portion 306 in various manners, such as clicking on the one or more styles using a cursor and cursor control device, touching the one or more styles when displayed on a touchscreen, audible commands such as speaking the name of the style, and so forth. By selecting a single style name from the portion 306, the automatic content styling system 106 is notified of the style (the various attribute settings for the style) as well as the one or more named entity categories to which the style corresponds.

The user interface 300 also includes a new style creation screen 320 allowing a user to create a new style and corresponding named entity category by specifying the attributes of the style and one or more named entity categories corresponding to the style. The new style creation screen 320 is displayed, for example, in response to user selection of the new style option 310. Portion 322 allows the user to specify the name of the style as well as various attributes of the style, such as font, font style, size, and color. Drop down menus for these various attributes allow a user to select particular settings for each attribute.

Portion 324 allows a user to select one or more named entity categories that correspond to the new style. The one or more named entity categories corresponding to the new style indicate the one or more named entity categories to which the attribute settings specified in portion 322 apply. As illustrated, these categories include “Facility”, “Event”, “Product”, and “Money”. A scroll bar 326 allows the user to scroll through multiple different styles. The user can select one or more categories from the portion 324 in various manners, such as clicking on the one or more categories using a cursor and cursor control device, touching the one or more categories when displayed on a touchscreen, audible commands such as speaking the name of the category, and so forth. Once the user has specified the attributes of the style and one or more named entity categories corresponding to the style, the user can select a “Create” button 328 to have the new style created and saved.

In the example user interface 300, the user can define styles (select various attribute settings for the style) and assign a name to those styles as well as one or more named entity categories to which each style corresponds. These defined styles, names, and corresponding one or more named entity categories are stored by the configuration module 202 (e.g., in storage 110) as a style record. These style records can be later retrieved by the configuration module 202 and displayed to the user for selection when creating the current digital content 210 as well as when creating other digital content. Thus, the user can define a style and specify one or more named entity categories to which the style corresponds once and then use that style when creating multiple different digital content.

In one or more implementations, a style is applied by the styling module 206 to all occurrences of the corresponding one or more categories in the digital content as discussed in more detail below. Additionally or alternatively, the configuration module 202 allows the user to specify one or more conditions that are to be satisfied in order for the style to be applied to an occurrence of a category. These conditions can be specified in various manners, such as using regular expressions. Regular expressions allow a user to specify patterns in digital content, such as the presence or absence of particular characters, the presence of absence of any character (e.g., a wildcard value), a location in the digital content, and so forth. For a defined style, name, and corresponding one or more categories, these one or more conditions are stored along with the defined style (e.g., in the style record) and used by the styling module 206 to determine whether to apply the defined style to a particular occurrence of a category.

For example, a user may specify that a particular style is to be applied to a particular named entity category only if that named entity category occurs in the first paragraph of the digital content. By way of another example, a user may specify that a particular style is applied to a particular named entity category but only once per paragraph in the digital content (e.g., for each paragraph, only the first time that named entity category occurs in the paragraph). By way of yet another example, a user may specify that a particular style is applied to only the first 5 occurrences of a particular named entity category in the digital content.

Returning to FIG. 2, the configuration module 202 provides the named entity category indication 216 to the named entity category identification module 204, which is an indication of the one or more named entity categories specified by the user. The user specifies the one or more categories by, for example, selecting a style name as discussed above with reference to FIG. 3. The named entity category identification module 204 also receives the digital content 210 that the user is creating. The named entity category identification module 204 implements functionality to identify the occurrences of the indicated named entity category 216 in the digital content 210.

In one or more implementations, the named entity category identification module 204 is implemented at least in part as a machine learning system. Machine learning systems refer to a computer representation that can be tuned (e.g., trained) based on inputs to approximate unknown functions. In particular, machine learning systems can include a system that utilizes algorithms to learn from, and make predictions on, known data by analyzing the known data to learn to generate outputs that reflect patterns and attributes of the known data. For instance, a machine learning system can include decision trees, support vector machines, linear regression, logistic regression, Bayesian networks, random forest learning, dimensionality reduction algorithms, boosting algorithms, artificial neural networks, deep learning, and so forth.

For example, the named entity category identification module 204 can employ one or more convolutional neural networks (CNNs). A CNN is formed from layers of nodes (i.e., neurons) and can include various layers such as an input layer, an output layer, and one or more hidden layers such as convolutional layers, pooling layers, activation layers, fully connected layers, normalization layers, and so forth.

The named entity category identification module 204 can be implemented as one or more machine learning systems. For example, the named entity category identification module 204 can be implemented as a single machine learning system that is a multi-classification system trained to identify each of multiple different named entity categories. By way of another example, the named entity category identification module 204 can be implemented as multiple machine learning systems each trained to identify a subset (e.g., a single one) of multiple different named entity categories.

Each such machine learning system of the named entity category identification module 204 is trained to identify one or more named entity categories. Such a machine learning system can be trained in various different manners. In one or more implementations, the machine learning system is trained by providing training data including digital content with the one or more named entity categories tagged. The machine learning system identifies the one or more named entity categories in the digital content, compares the identified one or more named entity categories to the correct one or more named entity categories (as tagged), and adjusts various weights in the machine learning system to minimize a loss function.

It should be noted that the training data including digital content with the one or more named entity categories tagged can include not just the named entities but additional context around the named entities. For example, the training data can include multiple words before or after the named entity, such as the sentence or paragraph that the named entity is in. This allows the machine learning system to learn context around a named entity to better identify the named entity as an occurrence of a named entity category.

Furthermore, the context around a named entity allows the machine learning system to identify the usage of the named entity. Some named entities may be classified into multiple categories and the use of context around the named entity allows the machine learning system to accurately identify whether the named entity, as used in the digital content 210, is an occurrence of the indicated one or more named entity categories 216. For example, the named entity “Ford” is classified in both the Person category and the Organization category. If the indicated one or more named entity categories 216 is the Person category, then taking into account the context around the word “Ford” allows the machine learning system to accurately identify uses of the word “Ford” as a person in the digital content 210 as occurrences of the indicated one or more named entity categories 216 while also not identifying uses of the word “Ford” as an organization in the digital content 210 as occurrences of the indicated one or more named entity categories 216.

In one or more implementations, a machine learning system of the named entity category identification module 204 is trained for a particular use case. For example, a shoe company may desire to generate digital content (e.g., a shoe catalog or a webpage) and assign a particular style to each of their product names in the digital content. In this example, each machine learning system of the named entity category identification module 204 is trained by providing training data including digital content with the one or more product names tagged.

Additionally or alternatively, a machine learning system of the named entity category identification module 204 is trained for a particular language. Different languages oftentimes have different structures and named entities (e.g., people's names in one language may differ significantly from people's names in another language). A machine learning system of the named entity category identification module 204 can be trained by providing training data including digital content in a particular language with the categories in that language tagged.

The named entity category identification module 204 identifies the occurrences of the indicated named entity category 216 in the digital content 210 and generates an indication 218 of these named entity category occurrences. The named entity category occurrences indication 218 identifies the location in the digital content 210 of each occurrence of the indicated named entity category 216 that the named entity category identification module 204 identified. The named entity category occurrences indication 218 can identify the locations of the occurrences in a variety of different manners. For example, the paragraphs in the digital content can be numbered and the words within each paragraph numbered (as an offset from the beginning of the paragraph) and the locations can be specified by paragraph number and word number. By way of another example, the words in the digital content can be numbered and the locations specified by word number.

In addition to providing the named entity category indication 216 to the named entity category identification module 204, the configuration module 202 also provides the style indication 214 to the styling module 206. The style indication 214 is an indication of the user specified style, including the attribute settings for the style. The styling module 206 also receives the digital content 210 and implements functionality to apply the style indication 214 to the occurrences of the named entity category 218 in the digital content 210 to generate styled digital content 220. Applying the style indication 214 to the occurrences of the named entity category 218 includes changing the style of each occurrence of the named entity category to the style indicated by the style indication 214. For example, the attribute settings of each occurrence of the named entity category in the digital content 210 are changed to the attribute settings indicated in the style indication 214.

In one or more implementations, the styling module 206 changes the attribute settings for each occurrence of the named entity category identified in the named entity category occurrences indication 218. Additionally or alternatively, as discussed above the style indication 214 may identify one or more conditions that are to be satisfied in order for the style to be applied to an occurrence of a category. In such situations, the styling module 206 changes the attribute settings of only those occurrences of the named entity category that satisfy the one or more conditions. Thus, in such situations the attribute settings of a subset (less than all) of the occurrences of the named entity category identified in the named entity category occurrences indication 218 are changed.

The styling module 206 provides the styled digital content 220 to the output module 208. The output module 208 causes the styled digital content 220 to be displayed (e.g., on the display device 114). Additionally or alternatively, the output module 208 causes the styled digital content 220 to be output in other manners, such as stored on a storage device (e.g., locally to the computing device 102 or accessed via the network 116), transmitted to another computing device for storage or display, and so forth.

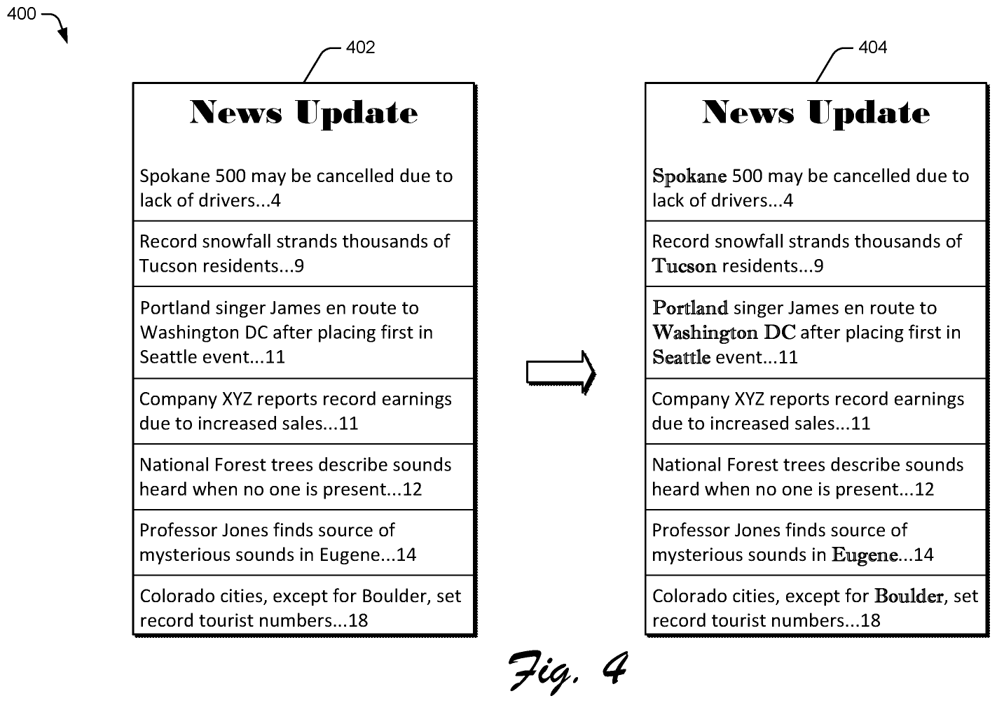

FIG. 4 illustrates an example 400 of the operation of the automatic content styling system 106. In the example 400, digital content 402 is illustrated as a news update document including the titles of several news stories and the page of a magazine where the articles can be found. For example, the article “Record snowfall strands thousands of Tucson residents” can be found at page 9.

Assume that a user desires to change the font and the font style for all occurrences of geographic names in the digital content 402 (e.g., names of countries, cities, states, provinces, and so forth). The user specifies the font, the font style, and the named entity category (geographic names) and the automatic content styling system 106 generates styled digital content 404. As illustrated, the font and font style for all occurrences of geographic names in the digital content 402 have been changed.

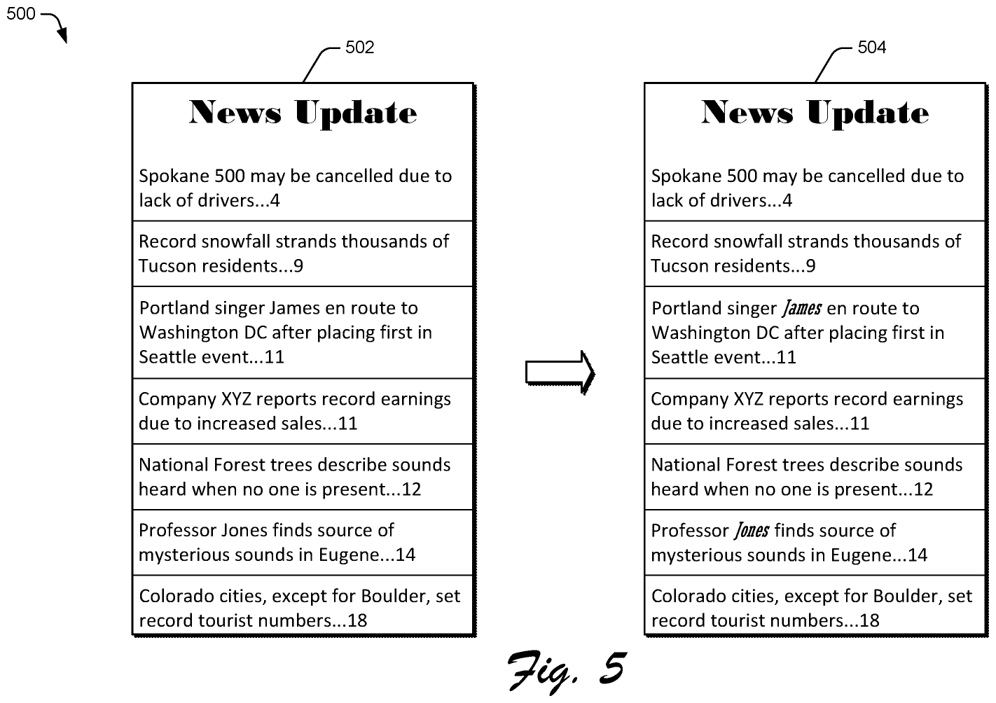

FIG. 5 illustrates another example 500 of the operation of the automatic content styling system 106. In the example 500, digital content 502 is illustrated as a news update document including the titles of several news stories and the page of a magazine where the articles can be found. For example, the article “Portland singer James en route to Washington D.C. after placing first in Seattle event” can be found at page 11.

Assume that a user desires to change the font and the font style of all of the occurrences of people's names in the digital content 502. The user specifies the font, the font style, and the named entity category (person or people) and the automatic content styling system 106 generates styled digital content 504. As illustrated, the font and font style for all of the occurrences of people's names in the digital content 502 have been changed.

Returning to FIG. 2, additional user input 226 is also received by the monitoring module 222. The user input 226 is user input provided to the digital content creation system 104 after the styling module 206 generates the styled digital content 220. The user input 226 can be any of a variety of different editing inputs, such as adding text, images, video, and so forth to the styled digital content 220, deleting text, images, video and so forth from the styled digital content 220, changing the style of one or more characters in the styled digital content 220, and so forth.

The monitoring module 222 also receives the named entity category occurrences indication 218. The monitoring module 222 identifies false positives generated by the named entity category identification module 204 (occurrences of the named entity category identified by the named entity category identification module 204 that were not actually the named entity category) and false negatives generated by the named entity category identification module 204 (occurrences of the named entity category that were not identified by the named entity category identification module 204).

The monitoring module 222 provides a false positive or negative indication 228 to the training module 224, notifying the training module 224 of at least one false positive or at least one false negative generated by the named entity category identification module 204. The training module 224 uses these false positives and false negatives to further train the machine learning system of the named entity category identification module 204, adjusting various weights in the machine learning system to minimize a loss function based on the false positives or false negatives.

In one or more implementations, the named entity category identification module 204 also provides a context indication 232 to the monitoring module 222. The context indication 232 is the context of each occurrence of the named entity category identified in the named entity category occurrences indication 218. The monitoring module 222 can include this context for each false positive or negative indication 228, allowing the training module 224 to use the context of a false positive or false negative in further training the machine learning system.

The named entity category identification module 204 can thus be continually learning over time while in use. This improves the accuracy of the named entity category identification module 204 in identifying named entity categories while the user is using the automatic content styling system 106.

The monitoring module 222 can identify false positives and false negatives in a variety of different manners. In one or more implementations, user input 226 is received specifying one or more characters (e.g., specifying at least one word or number) in the styled digital content 220 that are a false positive or a false negative. The user can specify one or more such characters in a variety of different manners, such as by selecting the one or more characters (e.g., highlighting the characters, touching or clicking on a word in a sentence) and selecting a user interface element (e.g., a button, an icon, a menu item) or providing another input (e.g., audible input, gesture) indicating “false positive” or “false negative”.

User specification of a false negative can also cause the monitoring module 222 to notify the styling module 206 of the occurrence, and in response the styling module 206 applies the style indication 214 to the false negative. In one or more implementations the styling module 206 also maintains a record of the occurrences of the named entity category to which the style indication 214 was applied as well as the style (e.g., attribute settings) for each such occurrence prior to application of the style indication 214. This allows the styling module 206 to undo the application of the style indication 214 to an identified occurrence of the named entity category, returning that identified occurrence of the named entity category to the style it had prior to application of the style indication 214. Accordingly, user specification of a false positive can also cause the monitoring module 222 to notify the styling module 206 of the occurrence, and in response the styling module 206 undoes the application of the style indication 214 to the false positive.

For example, assume the named entity category is Geographic and the style indication 214 indicates to make that named entity category red in capital letters. If the named entity category identification module 204 did not identify an occurrence of the word “Montana” in the digital content 210 as an occurrence of the named entity category, then the styling module 206 would not have changed that occurrence of “Montana” to red in capital letters. The user can select the word “Montana” in the styled digital content 220 (e.g., by highlighting the word, by clicking on or touching one of the letters in the word) and then select a “false negative” icon. In response, the monitoring module 222 notifies the training module 224 of the false negative and the training module 224 uses that false negative to further train the named entity category identification module 204. Furthermore, the monitoring module 222 can notify the styling module 206 of the false negative, and in response the styling module 206 applies the style indication 214 (e.g., the most recently received style indication) to the word “Montana”.

By way of another example, assume the named entity category is Geographic and the style indication 214 indicates to make that named entity category red in capital letters. If the named entity category identification module 204 identified an occurrence of the word “mistake” in the digital content 210 as an occurrence of the named entity category, then the styling module 206 would have changed that occurrence of “mistake” to red in capital letters. The user can select the word “mistake” in the styled digital content 220 (e.g., by highlighting the word, by clicking on or touching one of the letters in the word) and then select a “false positive” icon. In response, the monitoring module 222 notifies the training module 224 of the false positive and the training module 224 uses that false positive to further train the named entity category identification module 204. Furthermore, the monitoring module 222 can notify the styling module 206 of the false positive, and in response the styling module 206 undoes the application of the style indication 214 (e.g., the most recently received style indication) to the word “mistake”.

Additionally or alternatively, the monitoring module 222 can automatically identify false positives and false negatives in a variety of different manners. In one or more implementations, the monitoring module 222 receives the style indication 214 and associates the style indication 214 with the named entity category occurrences indication 218. This association can be made in a variety of different manners. For example, the configuration module 202 can add an identifier (e.g., a globally unique identifier or an identifier unique within the automatic content styling system 106) to the style indication 214 as well as to the named entity category indication 216. The named entity category identification module 204 can include this identifier in the named entity category occurrences indication 218. Given these identifiers, the monitoring module 222 can associate the style indication 214 with the named entity category occurrences indication 218.

By way of another example, the monitoring module 222 can assume that the monitoring module 222 will receive the named entity category occurrences indication 218 soon after receiving the style indication 214. Accordingly, the monitoring module 222 can associate the named entity category occurrences indication 218 with the style indication 214 if the named entity category occurrences indication 218 is received within a threshold amount of time (e.g., 2 seconds) of receiving the style indication 214. This threshold amount of time can be set by various individuals, such as the user, a designer or developer of the automatic content styling system 106, and so forth. This threshold amount of time can be set empirically based on how long the named entity category identification module 204 takes to generate the named entity category occurrences indication 218 and how quickly a user is expected to select another style to apply to another named entity category to help ensure that the monitoring module 222 does not associate the next selected style indication with the previously selected named entity category occurrences indication.

The monitoring module 222 can automatically identify a false negative by detecting that one or more characters that were not identified as the named entity category are changed by the user (via user input 226) to be the same style as the associated style indication 214. Given the named entity category occurrences indication 218 and an associated style indication 214, this detection can be readily performed by the monitoring module 222.

The monitoring module 222 can automatically identify a false positive by detecting that one or more characters that were identified as the named entity category are changed by the user (via user input 226) to no longer be the same style as the style indication 214. Given the named entity category occurrences indication 218 and an associated style indication 214, this detection can be readily performed by the monitoring module 222.

Additionally or alternatively, as discussed above the styling module 206 can also maintain a record of the occurrences of the named entity category to which the style indication 214 was applied as well as the style (e.g., attribute settings) for each such occurrence prior to application of the style indication 214. The styling module 206 can further provide this record to the monitoring module 222 to allow the monitoring module 222 to detect if the user input 226 changes the style of one or more characters to be the style the one or more characters had prior to application of the style indication 214. The monitoring module 222 can automatically identify a false positive by detecting that one or more characters that were identified as the named entity category are changed by the user (via user input 226) to be the style the one or more characters had prior to application of the style indication 214.

In one or more implementations the monitoring module 222 monitors user input 226 to identify false positives and false negatives for only a threshold amount of time (e.g., 1 minute) after receipt of the named entity category occurrences indication 218. This threshold amount of time can be set by various individuals, such as the user, a designer or developer of the automatic content styling system 106, and so forth. This threshold amount of time can be set empirically based on how soon after user input 212 specifying a style to apply a user is expected to correct any false positives or false negatives. By stopping monitoring user input 226, the monitoring module 222 need not operate and expend resources attempting to identify false positives or false negatives that may be corrected by the user.

It should be noted that the receipt of user input 212 specifying a style with corresponding named entity category can be repeated any number of times, allowing different styles to be applied to different named entity categories. Effectively, after the styled digital content 220 is generated, the styled digital content 220 becomes the digital content 210 for the next user input 212.

It should also be noted that although the application of different styles to different named entity categories can be used with regular expressions, the techniques discussed herein differ from using just regular expressions. Conventional regular expressions are unable to identify named entity categories. Furthermore, conventional regular expressions require the user to identify and describe a pattern that differentiates the text he desires to apply one style to from the text he desires to apply another style to. These rules can be complicated and difficult to create, and in some situations simply cannot be created. For example, a user may desire to assign a particular style to company names that are present in digital content. The company names may be located in various parts of the digital content (e.g., the beginning of some sentences, the middle of other sentences, the ends of other sentences, combinations thereof) and there may not be any pattern that can be described with regular expressions indicating the locations of those company names or the letters in the company names. The techniques discussed herein alleviate the need to generate such rules.

Furthermore, there may be numerous possibilities for a named entity category. For example, there may be tens or hundreds of thousands of company names in existence. The user would typically not know all possible company names and even if all possibilities were known generating rules to identify each individual company name would be tedious and time consuming. The techniques discussed herein alleviate the need to generate such rules.

It should further be noted that although the discussion herein refers to named entities and named entity categories, the techniques discussed herein can be applied analogously to various other parts of speech, including nouns, pronouns, verbs, adjectives, adverbs, prepositions, conjunctions, and interjections. Further, each of these parts of speech can be sub-divided into multiple categories (e.g., verbs can be sub-divided into categories of action verbs, linking verbs, and helping verbs). The automatic content styling system 106 can additionally or alternatively implement functionality to automatically apply a style to characters that are part of a certain part of speech or category of part of speech in the same manner as a style is applied to characters that are part of a certain named entity category in the digital content.

Example Procedures

The following discussion describes techniques that may be implemented utilizing the previously described systems and devices. Aspects of the procedure may be implemented in hardware, firmware, software, or a combination thereof. The procedure is shown as a set of blocks that specify operations performed by one or more devices and are not necessarily limited to the orders shown for performing the operations by the respective blocks. In portions of the following discussion, reference will be made to FIGS. 1-5.

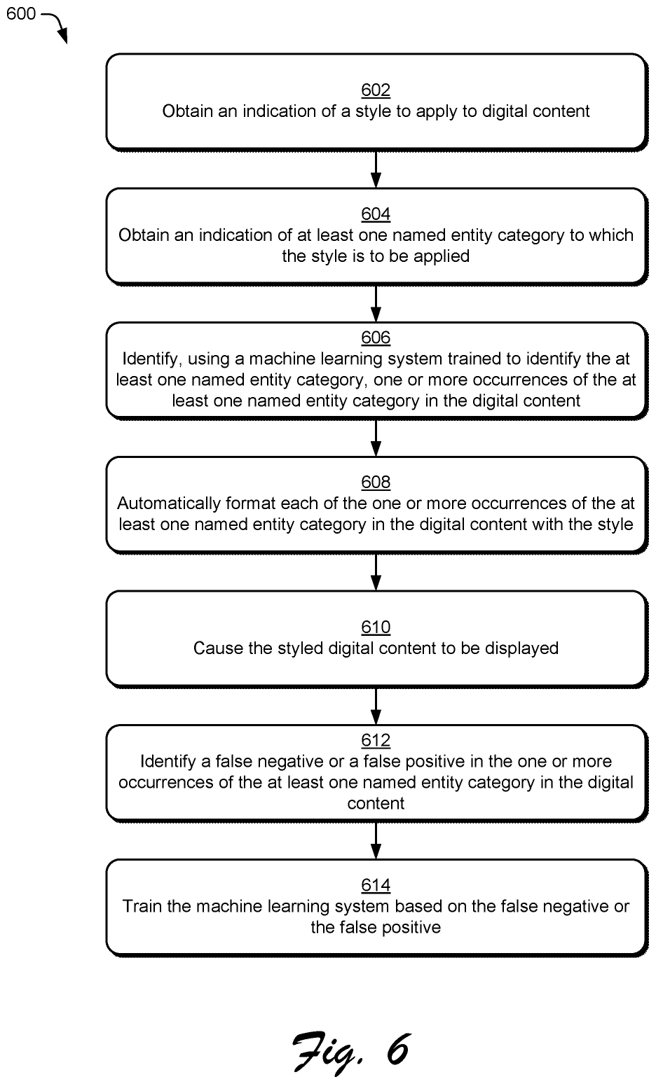

FIG. 6 is a flow diagram 600 depicting a procedure in an example implementation of automatically styling content based on named entity recognition. In this example, an indication of a style to apply to digital content is obtained (block 602). This style is, for example, a user specified style.

An indication of at least one named entity category to which the style is to be applied is also obtained (block 604). This named entity category is, for example, a user specified named entity category.

One or more occurrences of the at least one named entity category are identified (block 606). These one or more occurrences are identified by a machine learning system trained to identify the at least one named entity category.

Each of the one or more occurrences of the at least one named entity category in the digital content is automatically formatted with the style (block 608), resulting in style digital content. This styled digital content is caused to be displayed (block 610) on a display device.

A false negative or a false positive in the one or more occurrences of the at least one named entity category in the digital content is also identified (block 612). A false negative refers to an occurrence of the named entity category in the digital content that were not identified in block 606. A false positive refers to an occurrence of the named entity category identified in block 606 that were not actually the named entity category.

In response to identifying the false negative or the false positive, the machine learning system is trained based on the false negative or the false positive (block 614). This is further training for the machine learning system previously trained to identify the at least one named entity category, improving the accuracy in identifying occurrences of the at least one named entity category based on the identified false negative or false positive.

The procedure depicted in flow diagram 600 can be repeated any number of times. This allows the user to apply different styles to be applied to each of multiple different named entity categories.

Example System and Device

FIG. 7 illustrates an example system generally at 700 that includes an example computing device 702 that is representative of one or more computing systems and/or devices that may implement the various techniques described herein. This is illustrated through inclusion of the digital content creation system 104 with the automatic content styling system 106. The computing device 702 may be, for example, a server of a service provider, a device associated with a client (e.g., a client device), an on-chip system, and/or any other suitable computing device or computing system.

The example computing device 702 as illustrated includes a processing system 704, one or more computer-readable media 706, and one or more I/O interface 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware element 710 that may be configured as processors, functional blocks, and so forth. This may include implementation in hardware as an application specific integrated circuit or other logic device formed using one or more semiconductors. The hardware elements 710 are not limited by the materials from which they are formed, or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 706 is illustrated as including memory/storage 712. The memory/storage 712 represents memory/storage capacity associated with one or more computer-readable media. The memory/storage component 712 may include volatile media (such as random access memory (RAM)) and/or nonvolatile media (such as read only memory (ROM), Flash memory, optical disks, magnetic disks, and so forth). The memory/storage component 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 702. By way of example, and not limitation, computer-readable media may include “computer-readable storage media” and “computer-readable signal media.”

“Computer-readable storage media” refers to media and/or devices that enable persistent and/or non-transitory storage of information in contrast to mere signal transmission, carrier waves, or signals per se. Computer-readable storage media is non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refers to a signal-bearing medium that is configured to transmit instructions to the hardware of the computing device 702, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that may be employed in some implementations to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of a module that is executable by the computing device 702 as software may be achieved at least partially in hardware, e.g., through use of computer-readable storage media and/or hardware elements 710 of the processing system 704. The instructions and/or functions may be executable/operable by one or more articles of manufacture (for example, one or more computing devices 702 and/or processing systems 704) to implement techniques, modules, and examples described herein.

The techniques described herein may be supported by various configurations of the computing device 702 and are not limited to the specific examples of the techniques described herein. This functionality may also be implemented all or in part through use of a distributed system, such as over a “cloud” 714 via a platform 716 as described below.

The cloud 714 includes and/or is representative of a platform 716 for resources 718. The platform 716 abstracts underlying functionality of hardware (e.g., servers) and software resources of the cloud 714. The resources 718 may include applications and/or data that can be utilized while computer processing is executed on servers that are remote from the computing device 702. Resources 718 can also include services provided over the Internet and/or through a subscriber network, such as a cellular or Wi-Fi network.

The platform 716 may abstract resources and functions to connect the computing device 702 with other computing devices. The platform 716 may also serve to abstract scaling of resources to provide a corresponding level of scale to encountered demand for the resources 718 that are implemented via the platform 716. Accordingly, in an interconnected device embodiment, implementation of functionality described herein may be distributed throughout the system 700. For example, the functionality may be implemented in part on the computing device 702 as well as via the platform 716 that abstracts the functionality of the cloud 714.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a content creation digital medium environment, a method implemented by at least one computing device, the method comprising:
obtaining, by the at least one computing device, an indication of a style to apply to digital content;
obtaining, by the at least one computing device, an indication of at least one named entity category to which the style is to be applied;
identifying, by a machine learning system of the at least one computing device trained to identify the at least one named entity category, one or more occurrences of the at least one named entity category in the digital content;
automatically formatting, by the at least one computing device, each of the one or more occurrences of the at least one named entity category in the digital content with the style, resulting in styled digital content;
causing, by the at least one computing device, the styled digital content to be displayed;
identifying, by the at least one computing device, a false negative or a false positive in the one or more occurrences of the at least one named entity category in the digital content; and
training, by the at least one computing device responsive to identifying the false negative or the false positive, the machine learning system based on the false negative or the false positive.

2. The method as recited in claim 1, the method further comprising:
obtaining, by the at least one computing device, an indication of one or more conditions that are to be satisfied in order for the style to be applied to an occurrence of a named entity category in the digital content; and
the automatically formatting comprising automatically formatting only occurrences of the one or more occurrences of the named entity category in the digital content that satisfy the one or more conditions with the style.

3. The method as recited in claim 1, the style comprising one or more attributes that control the appearance of characters in the digital content.

4. The method as recited in claim 1, the obtaining the indication of the style and the obtaining the indication of the at least one named entity category comprising receiving user input specifying the style and the at least one named entity category.

5. The method as recited in claim 1, further comprising displaying a user interface and receiving, via the user interface, user input to create and store the style and the at least one named entity category.

6. The method as recited in claim 1, the identifying the false negative or the false positive comprising automatically identifying the false negative or the false positive based on the one or more occurrences of the at least one named entity category in the digital content as well as a user input changing a style of one or more characters in the digital content.

7. The method as recited in claim 1, the identifying the false negative or the false positive comprising identifying the false negative or the false positive based on user input specifying that one or more characters of the digital content are a false negative or a false positive.

8. The method as recited in claim 1, the identifying the false negative or the false positive comprising identifying a false negative, and the method further comprising automatically formatting the false negative with the style.

9. The method as recited in claim 1, the identifying the false negative or the false positive comprising identifying a false positive, and the method further comprising returning the false positive to a prior style that the false positive had prior to automatically formatting the false positive with the style.

10. The method as recited in claim 1, the at least one named entity category comprising a user-defined named entity category.

11. In a content creation digital medium environment, a computing device comprising:
a processor; and
computer-readable storage media having stored thereon multiple instructions that, responsive to execution by the processor, cause the processor to perform operations including:
receiving user input specifying a style to apply to at least one named entity category in digital content;
identifying, by a machine learning system trained to identify the at least one named entity category, one or more occurrences of the at least one named entity category in the digital content;
applying the style to each of the one or more occurrences of the at least one named entity category in the digital content, resulting in styled digital content;
causing the styled digital content to be displayed;
identifying a false negative or a false positive in the one or more occurrences of the at least one named entity category in the digital content; and
training the machine learning system based on the false negative or the false positive.

12. The computing device as recited in claim 11, the operations further including displaying a user interface and receiving, via the user interface, user input to create and store the style and the at least one named entity category.

13. The computing device as recited in claim 11, the identifying the false negative or the false positive comprising automatically identifying the false negative or the false positive based on the one or more occurrences of the at least one named entity category in the digital content as well as a user input changing a style of one or more characters in the digital content.

14. The computing device as recited in claim 11, the identifying the false negative or the false positive comprising identifying the false negative or the false positive based on user input specifying that one or more characters of the digital content are a false negative or a false positive.

15. The computing device as recited in claim 11, the identifying the false negative or the false positive comprising identifying a false negative, and the operations further comprising automatically formatting the false negative with the style.

16. The computing device as recited in claim 11, the identifying the false negative or the false positive comprising identifying a false positive, and the operations further comprising returning the false positive to a prior style that the false positive had prior to automatically formatting the false positive with the style.

17. The computing device as recited in claim 11, the operations further including:
receiving additional user input specifying an additional style to apply to a part of speech other than the at least one named entity category in the digital content;
identifying, by the machine learning system trained, one or more occurrences of the part of speech in the digital content;
applying the additional style to each of the one or more occurrences of the part of speech in the digital content, resulting in additionally styled digital content; and
causing the additionally styled digital content to be displayed.

18. A system comprising:
a configuration module, implemented at least in part in hardware, to receive user input specifying a style to apply to at least one named entity category in digital content;
means for automatically formatting each of one or more occurrences of the at least one named entity category in the digital content with the style and for improving accuracy in identifying occurrences of the at least one named entity category based on an identified false negative or false positive in the one or more occurrences; and
an output module, implemented at least in part in hardware, causing the digital content with the automatically formatted one or more occurrences of the at least one named entity category to be displayed.

19. The system as recited in claim 18, the style comprising one or more attributes that control the appearance of characters in the digital content.

20. The system as recited in claim 18, further comprising a monitoring module, implemented at least in part in hardware, to return an identified false positive to a prior style that the false positive had prior to automatically formatting the false positive with the style.
